(19) United States
(12) Patent Application Publication
(10) Pub. No.: US 2012/0097023 A1
(43) Pub. Date: Apr. 26, 2012

(54) Load Cylinder For Compensating Unbalanced Forces

(75) Inventors: Antonio Valor Valor, Arrasate-Mondragon (ES); Jon Hernando Gartaonandia, Vitoria-Gasteiz (ES)

(73) Assignee: NITROGAS, S.A.U., Minano (ES)

(21) Appl. No.: 13/377,797

(22) PCT Filed: Jun. 4, 2010
(86) PCT No.: PCT/EP2010/057823

§ 371 Date: Dec. 12, 2011

(30) Foreign Application Priority Data
Jun. 12, 2009 (ES) P 200930299

(51) Int. Cl. F15B 15/20

(52) U.S. Cl. 92/113

(57) ABSTRACT

A load cylinder for compensating unbalanced forces applied by a load. According to one implementation the load cylinder comprises a hollow ring-shaped body, a base fixed to a first end of the ring-shaped body, and a rod housed partially in the hollow space of the ring-shaped body, a chamber being delimited between side walls of the ring-shaped body, the rod and the base. The rod is housed partially in the chamber and may move in its interior. The rod comprises a housing on one end, and the load cylinder comprises a compensation member housed in the housing, the compensation member being acted on to cause the movement of the rod. The housing comprises a greater width than the width of the compensation member, with the result that the compensation member may move inside the housing.

### CROSS-REFERENCE TO RELATED APPLICATIONS

The present application is a 374 PCT national phase application of and thus claims the benefit and priority accordingly of International Application No. PCT/EP2010/057823, filed Jun. 4, 2010 which claims the benefit of priority to Spanish Patent Application No. P200930299, filed Jun. 12, 2009.

### TECHNICAL FIELD

The present invention relates to load cylinders, and more specifically to load cylinders adapted for compensating imbalances in the force exerted by the load.

### BACKGROUND

Material-forming installations comprise a press and a die that is arranged in the press. The die comprises a matrix and a male between which is arranged the material for forming, the matrix moving towards the male (or vice versa) in order to form it. Normally, the dies comprise a hold-down board to control the flow of the sheet material, which is moved by the movement of the matrix (or the male). The hold-down board also comprises a window through which the male (or matrix) comes out when the hold-down board moves, the metal sheet being formed as a result. The down force is achieved by applying a force on the hold-down board through cylinders in the press itself, the cylinders increasing their force as they are compressed by the movement of the die.

The cylinders comprise a casing and a piston that delimit and internal chamber of the cylinder. The piston moves inside the chamber as a result of the movement of the die, causing the reduction in the volume of the camber. One of the cylinders is disclosed, for example, in document WO 2009043594.

Generally speaking, due to the assembly of the die and/or its use, for example, the movement caused by the die in the piston is not completely vertical and causes the piston to exert unwanted forces against at least one of the internal walls of the casing of the cylinder during its movement. As a result, due to the forces, it is often the case that the piston and/or the casing eventually break, thereby necessitating the replacement of the cylinder with a new one more frequently than is desirable.

Document U.S. Pat. No. 7,343,846 B2 discloses a cylinder that solves, at least partially, this drawback, and for this purpose the piston comprises a semi-circular piece which is acted to cause the movement of the piston. This piece is arranged in a substantially centred manner in relation to the longitudinal axis of the piston, and can pivot in relation to the longitudinal axis. When the surface of the die is not completely horizontal, this surface and the external surface of the semi-circular piece on which it acts to cause the movement of the piston are not aligned, so that the semi-circular piece pivots in relation to the longitudinal axis, aligning itself with the surface of the die. As a result, the piece rotates in order to adapt itself to the slope of the surface of the die and always exerts a vertical force on the rest of the piston, regardless of the slope, which moves vertically without generating lateral forces on any of the internal walls of the casing of the cylinder as a result of a misalignment between the die and the piston. As a result, the semi-circular piece supports and/or compensates the misalignment between the piston and the die and prevents the cylinder from breaking as a result of this problem.

### SUMMARY OF THE DISCLOSURE

According to one implementation a load cylinder is provided that comprises a hollow ring-shaped body with a closed first end and an open second end, a piston housed in the ring-shaped body that delimits a fluid chamber, a rod that is housed at least partially in the ring-shaped body through the open second end and which is fixed to the piston, and which can be moved in a longitudinal direction in one sense or the other, and a compensation member to compensate possible deviations in the movement of the rod, which is attached to the rod and on which it acts to cause the movement of the rod.

In one implementation the rod comprises, in one end opposite to the piston, a housing where the compensation member is housed. The housing comprises a greater width than the width of the compensation member, so that the compensation member can be moved inside the housing in a compensation direction, in one or another sense, to compensate possible deviations in the movement of the rod.

If an unbalanced force is exerted in a swinging manner on the compensation member, the compensation member can be moved in the compensation direction, in one or another sense, inside the housing in response to the swinging motion, the compensation member absorbing the swinging motion and applying a vertical force on the piston, so that the piston moves vertically without exerting lateral forces on the side walls of the ring-shaped body caused by the swinging motion. As a result, the swinging motion of the force that causes the movement of the piston does not affect the cylinder negatively.

These and other advantages and characteristics of the invention will be made evident in the light of the drawings and the detailed description thereof.

### BRIEF DESCRIPTION OF THE DRAWINGS

FIG. 1 shows a cross-section of a cylinder according to one implementation of the invention.

FIG. 2 shows, in detail, compensation members of the cylinder of FIG. 1.

### DETAILED DESCRIPTION

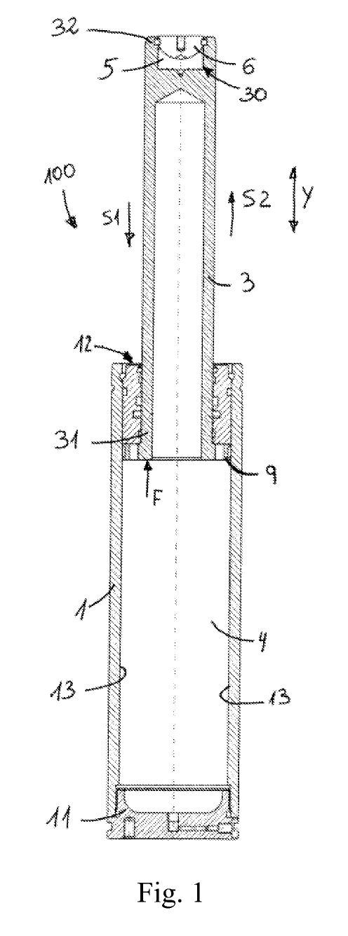

FIG. 1 shows an embodiment of the cylinder 100 of the invention, which comprises a hollow ring-shaped body 1 with a closed end 11 and an open end 12, a piston 9 housed in the ring-shaped body 1, and a rod 3 which is housed at least partially in the ring-shaped body 1 through the open second end 12, which is fixed to the piston 9, and which can be moved in a longitudinal direction Y in one sense or the other. In the ring-shaped body 1 is delimited a chamber 4 with fluid between the closed end 11 and the piston 9.

These types of cylinders 100 are generally used in stamping presses, and when the press performs a stamping action it acts on the rod 3, causing its movement in the direction of movement Y in a first sense S1. The chamber 4 comprises a fluid in its interior, preferably gas, and when the rod 3 moves in the first sense S1 the fluid is compressed as the piston 9 moves in conjunction with the rod 3, exerting a force F on the piston 9 that increases as the rod 3 moves in the first sense S1. When the rod 3 is no longer acted on, due to the force F exerted by the fluid on the piston 9, the rod 3 returns to its initial position moving in a second sense S2 opposite to the first sense S1.

In the cylinder 100 of the invention the rod 3 comprises a housing 30 on one end 32 opposite to the end 31 of the rod 3 by means of which it is fixed to the piston 9. The cylinder 100 comprises a compensation member 5 to compensate possible deviations in the movement of the rod 3, which is housed in the housing of the rod 3 and on which acts a load (a die in the press, for example) to cause the movement in the first sense S1 of the rod 3. The housing 30 comprises a greater width than the width of the compensation member 5, so that the compensation member 5 can be moved in a compensation direction X, in one or another sense, inside the housing 30.

The ideal situation occurs when the load acts on the rod 3 with a vertical force. If the force is not vertical, the load is regarded as acting on the rod 3 with unbalanced forces. As a result, with the cylinder 100 of the invention, when the load acts on the rod 3 with a force F1 that originates from the press that causes the movement of the rod 3, and which suffers variations in the compensation direction X in the manner of a swinging motion (an unbalanced force), the compensation member 5 compensates the swinging motion by moving in the compensation direction X. The compensation member 5 exerts a vertical force on the rod 3 causing it to move in a vertical manner in the first direction S1, the rod 3 not exerting any pressure or force on internal side walls 13 of the ring-shaped body 1. As a result, thanks to the compensation member 5, the risk of the swinging motion of the press affecting the useful life of the cylinder 100 due to the premature breakage of the rod 3 or the ring-shaped body 1 is prevented or reduced.

When arranged in the housing 30 of the rod 3, a contact surface 50 of the compensation member 5 is supported on a support surface 33 of the rod 3, with the compensation member 5 sliding on the support surface 33 when it moves in the compensation direction X. For this reason the contact surface 50 is preferably made of a material with a low friction coefficient, such as copper, thereby facilitating the movement. Preferably the compensation member 5 is made entirely of the material with a low friction coefficient.

In an embodiment, the compensation member 5 comprises a plurality of grooves 51 in the contact surface 50 which extend along the entire contact surface 50 and which are designed to receive lubricant and help the compensation member 5 to slide. The lubricant used may be any known lubricant, oil for example, and its purpose is to aid the movement of the compensation member 5 in the compensation direction X when necessary. The number of grooves 51 depends on the needs of the cylinder 100, and it can be sufficient in some cases to use a single groove 51 (or even no grooves 51). Rather than being arranged in the contact surface 50 of the compensation member 5, the groove 51 (or grooves) can be arranged on the support surface 33 of the housing 30 of the rod 3.

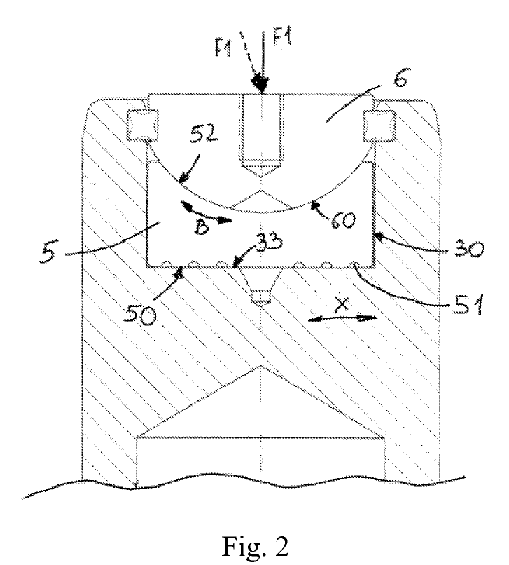

The cylinder 100 of the invention can also comprise an additional compensation member 6 arranged on the compensation member 5, as shown in FIGS. 1 and 2, in contact with the compensation member 5. The load acts directly on the additional compensation member 6, which transmits the action to the compensation member 5, which in turn transmits it to the rod 3, causing the movement of the rod 3 in the first sense S1. A contact surface 52, 60 between both compensation members 5 and 6 is semi-circular, so that if a force F1 exerted by the load on the additional compensation member 6 is not vertical (an unbalanced force) due to a misalignment between the contact surfaces between the rod 3 and the load, a force F1 shown in FIG. 2 with dotted lines, the additional compensation member 6 balances in relation to the compensation member 5 in response to the misalignment, in a balancing direction B in one sense or the other according to what is required, and transmits the force F1 to the compensation member 5 in a substantially vertical manner, causing a vertical movement of the rod 3 in the first sense 51.

Preferably, the contact surface 60 of the additional compensation member 6 is concave, and the contact surface 52 of the compensation member 5 is convex, although the reverse is also possible: the contact surface 60 of the additional compensation member 6 being convex, and the contact surface 52 of the compensation member 5 being concave.

1.-8. (canceled)

9. A load cylinder adapted to compensate for unbalanced forces applied by a load, the load cylinder comprising:
a hollow ring-shaped body having a first end and an open second end,
a piston housed and vertically moveable in the ring-shaped body, the piston and ring-shaped body delimiting a fluid chamber,
an elongate rod that extends at least partially into the ring-shaped body through the open second end, the elongate rod having a first end and a second end with the second end being fixed with the piston, the elongate rod moveable longitudinally with respect to the ring-shape body in first and second opposing longitudinal directions, the elongate rod comprising a housing in the first end having a first width dimension, the housing delineated by side walls and a bottom support surface,
a first compensation member on which the load acts fixed within the housing, the first compensation member having a bottom contact surface in sliding contact with the bottom support surface of the housing, the first compensation member comprising a second width dimension that is less than the first width dimension that facilitates a movement of the first compensating member within the housing that involves a sliding of the bottom contact surface along the bottom support surface of the housing when a non-longitudinal force is applied by the load.

10. A load cylinder according to claim 9, wherein the bottom contact surface of the first compensation member comprises a friction coefficient that allows the first compensation member to slide on the bottom support surface of the housing.

11. A load cylinder according to claim 9, wherein the first compensation member comprises at least one groove in the bottom contact surface.

12. A load cylinder according to claim 9, wherein the bottom support surface of the housing comprises at least one groove.

13. A load cylinder according to claim 11, further comprising a lubricant disposed within the groove.

14. A load cylinder according to claim 12, further comprising a lubricant disposed within the groove.

15. A load cylinder according to claim 11, wherein the groove extends along the entirety of the bottom contact surface.

16. A load cylinder according to claim 12, wherein the groove extends along the entirety of the bottom support surface.

17. A load cylinder according to claim 9, wherein the bottom contact surface of the first compensation member and the bottom support surface of the housing are flat.

18. A load cylinder according to claim 11, wherein the bottom contact surface of the first compensation member and the bottom support surface of the housing are flat.

19. A load cylinder according to claim 12, wherein the bottom contact surface of the first compensation member and the bottom support surface of the housing are flat.

20. A load cylinder according to claim 9, wherein the first compensating member has a semi-circular upper contact surface opposite the bottom contact surface, the load cylinder further comprising a second compensation member on which the load acts directly and which is arranged on the first compensation member, the second compensation member having a semi-circular bottom contact surface that is arranged to slide on the semi-circular upper contact surface of the first compensation member when a non-longitudinal force is applied by the load.

21. A load cylinder according to claim 20, wherein the semi-circular bottom contact surface of the second compensation member is concave and the semi-circular upper contact surface of the first compensation member is convex.

22. A load cylinder according to claim 20, wherein the semi-circular bottom contact surface of the second compensation member is convex, and the semi-circular upper contact surface of the first compensation member is concave.

23. A load cylinder adapted to compensate for unbalanced forces applied by a load, the load cylinder comprising:
a hollow ring-shaped body having a first end and an open second end,
a piston housed and vertically moveable in the ring-shaped body, the piston and ring-shaped body delimiting a fluid chamber,
an elongate rod that extends at least partially into the ring-shaped body through the open second end, the elongate rod having a first end and a second end with the second end being fixed with the piston, the elongate rod moveable longitudinally with respect to the ring-shape body in first and second opposing longitudinal directions, the elongate rod comprising a housing in the first end having a first width dimension, the housing delineated by side walls and a bottom support surface,
a first compensation member on which the load acts fixed within the housing, the first compensation member having a bottom contact surface in sliding contact with the bottom support surface of the housing, the first compensation member comprising a second width dimension that is less than the first width dimension that facilitates a movement of the first compensating member within the housing that involves a sliding of the bottom contact surface along the bottom support surface of the housing when a non-longitudinal force is applied by the load, the first compensating member having a semi-circular upper contact surface opposite the bottom contact surface; and
a second compensation member on which the load acts directly and which is arranged on the first compensation member, the second compensation member having a semi-circular bottom contact surface that is arranged to slide on the semi-circular upper contact surface of the first compensation member when a non-longitudinal force is applied by the load.

24. A load cylinder according to claim 23, wherein the bottom contact surface of the firs compensation member and the bottom support surface of the housing are fiat.

25. A load cylinder according to claim 24, wherein the first compensation member comprises at least one groove in the bottom contact surface.

26. A load cylinder according to claim 24, wherein the bottom support surface of the housing comprises at least one groove.

27. A load cylinder according to claim 25, further comprising a lubricant disposed within the groove.

28. A load cylinder according to claim 26, further comprising a lubricant disposed within the groove.

29. A load cylinder adapted to compensate for unbalanced forces applied by a load, the load cylinder comprising:
a hollow ring-shaped body having a first end and an open second end,
a piston housed and vertically moveable in the ring-shaped body, the piston and ring-shaped body delimiting a fluid chamber,
an elongate rod that extends at least partially into the ring-shaped body through the open second end, the elongate rod having a first end and a second end with the second end being fixed with the piston, the elongate rod moveable longitudinally with respect to the ring-shape body in first and second opposing longitudinal directions, the elongate rod comprising a housing in the first end having a first width dimension, the housing delineated by side walls and a flat bottom support surface,
a first compensation member on which the load acts fixed within the housing, the first compensation member having a flat bottom contact surface in sliding contact with the flat bottom support surface of the housing, the first compensation member comprising a second width dimension that is less than the first width dimension that facilitates a movement of the first compensating member within the housing that involves a sliding of the flat bottom contact surface along the fiat bottom support surface of the housing when a non-longitudinal force is applied by the load, the first compensating member having a semi-circular upper contact surface opposite the flat bottom contact surface; and
a second compensation member on which the load acts directly and which is arranged on the first compensation member, the second compensation member having a semi-circular bottom contact surface that is arranged to slide on the semi-circular upper contact surface of the first compensation member when a non-longitudinal force is applied by the load.

30. A load cylinder according to claim 29, wherein the first compensation member comprises at least one groove in the bottom contact surface.

31. A load cylinder according to claim 29, wherein the bottom support surface of the housing comprises at least one groove.

32. A load cylinder according to claim 30, further comprising a lubricant disposed within the groove.

33. A load cylinder according to claim 31, further comprising a lubricant disposed within the groove.
